(19) United States
(12) Patent Application Publication
(10) Pub. No.: US 2004/0020422 A1
(43) Pub. Date: Feb. 5, 2004

(54) Toxic material exposure indicator for pets

(76) Inventor: Steven Tsengas, Fairport Harbor, OH (US)

Correspondence Address: Law Offices of John D. Gugliotta, PE, Esq., 202 Delaware Building, 137 South Main Street, Akron, OH, 44308, US

(21) Appl. No.: 10/325,019

(22) Filed: Dec. 20, 2002

Related U.S. Application Data
(60) Provisional application No. 60/342,616, filed on Dec. 20, 2001.

(51) Int. Cl. G01D 21/00

(52) U.S. Cl. 116/206

(57) ABSTRACT

A toxic material sensor coating that may be used to indicate when a pet or has come into contact with a pesticide or other hazardous chemical is described. The sensor coating will change color upon exposure to subject chemicals. The sensor material may be positioned on a pet's collar or tag by means of an adhesive backing. The sensor material may be removable so that when one sensor device is spent, the device can be removed and a new sensor/indicator can be positioned in its place.

### TECHNICAL FIELD

The present invention relates to materials that indicate exposure to toxic materials such as pesticides. In particular the present invention relates to a toxic material sensor to be used with pets to indicate when the pet has been exposed to a pesticide or other potentially toxic material.

### BACKGROUND

It has been reported that over 90% of American households use some form of pesticides to eliminate or prevent the presence of insects in the home, yard or garden. Many times, these pesticides or insecticidal compounds are insoluable in water so that they remain around for long periods of time. Although these compounds are effective for keeping the bugs away from homes and plants, they can be dangerous to other living organisms in the area.

Pets, such as cats and dogs, are especially at risk for exposure to pesiticidal compounds placed on grass in lawns and other areas. Many of the chemicals in pesticides are soluble in fats. When pets are exposed to the pesticides the chemicals can accumulate in the liver and over time, can cause nerve, hormone or immune system problems.

Substantial accumulation of chemicals in the body of a pet and subsequent damage could be averted if a pet owner was able to detect when the pet had been exposed to the chemicals. The pet owner could bathe the pet to remove the chemicals before significant internalization of the chemicals. Unfortunately, the exposure is not visible to the naked eye. It would be beneficial to have a means to indicate when a pet has been exposed to potentially toxic chemicals so that a pet owner can take some type of action to minimize potential health problems for the pet.

### BRIEF DESCRIPTION OF THE DRAWINGS

FIG. 1 is an isometric view of a toxic material sensor/indicator in accordance with the present invention;

FIG. 2 is a view of a toxic material sensor/indicator shortly after exposure to a hazardous chemical;

FIG. 3 is a view of a toxic material sensor/indicator hours or days after exposure to a hazardous chemical;

FIG. 4 is an isometric view of a second embodiment of an environmental quality indicator in accordance with the present invention;

FIG. 5 illustrates a pet wearing a collar having a toxic material sensor/indicator positioned thereon;

FIG. 6 illustrates a typical pet collar;

FIG. 7 illustrates a first side of a tag such as one attached to a pet collar; and

FIG. 8 illustrates a second side of a tag shown in FIG. 7.

### DETAILED DESCRIPTION OF THE INVENTION

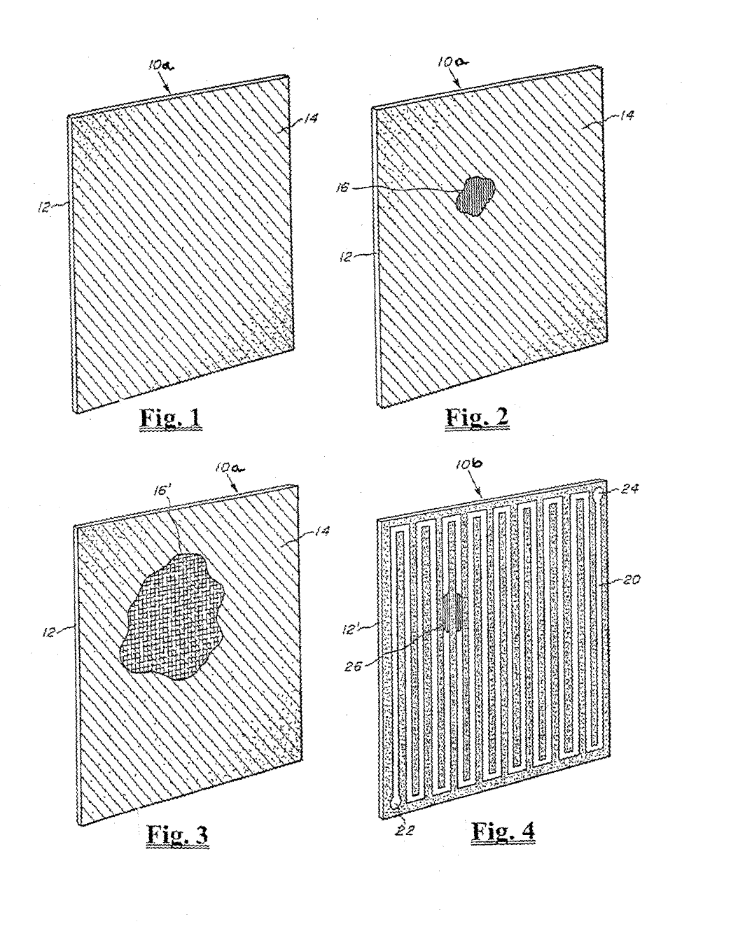

In FIGS. 1-3 the numeral 10 generally designates a toxic material sensor or indicator in accordance with the present invention. The indicator may be comprised of a generally inert porous substrate. Examples of suitable substrates may include sintered particules of polyethylene, polypropylene, nylon, and polyvinyl compounds. The pore sizes selected are determined by the ultimate drop size sensitivity desired. In testing for pesticides, a 30-micrometer pore-size polyethylene or polypropylene substrate 12 has been found to be satisfactory, although it is contemplated by the present invention that any other pore size which has been or will be determined to be substantially effective is covered by the present invention. An indicator formulation may be applied onto the substrate. The indicator formulation may be sprayed; painted, dipped or otherwise applied to the substrate. The indicator coating is generally designated 14 in FIGS. 1-3. The indicator coating 14 provides the surface of the substrate with a colored surface. It should be understood that any color surface is within the scope of the present invention.

In FIG. 2, the numeral 16 designates a spot which initially results from the contacting of indicator 14 by a chemical. The spot is shaded to indicate a color that is different from indicator coating 14. It should be understood that the color of spot 16 may be any color so long as it is distinguishable from the color of indicator coating 14.

In FIG. 3, the numeral 16′ designates an enlarged spot, which may be the result of spontaneous bleaching and the wicking effect of the chemical trapped within the porous substrate 12. The spot 16′ may be a the same color as spot 16 or a third color. Highly volatile liquids will show proportionally less bleaching and spot enlarging effects than will non-volatile chemicals such as organophosphorous pesticides.

In FIG. 4, the numeral 10′ generally designates a modified toxic material sensor/indicator that is automatic or active. Inert porous substrate 12′ has a circuit 20 located theron. In the form illustrated, silver particles are mixed with green indicator paint which produces a generally silver colored circuit 20 which connects contacts 22 and 24. Spot 26, which is shaded to indicate a second color, is produced when circuit 20 is contacted by the tested for chemical. It should be understood that the indicator circuit may be in a variety of colors and the spot 26 may also be a variety of colors so long as spot 26 is a color that is distinguishable from the circuit 20.

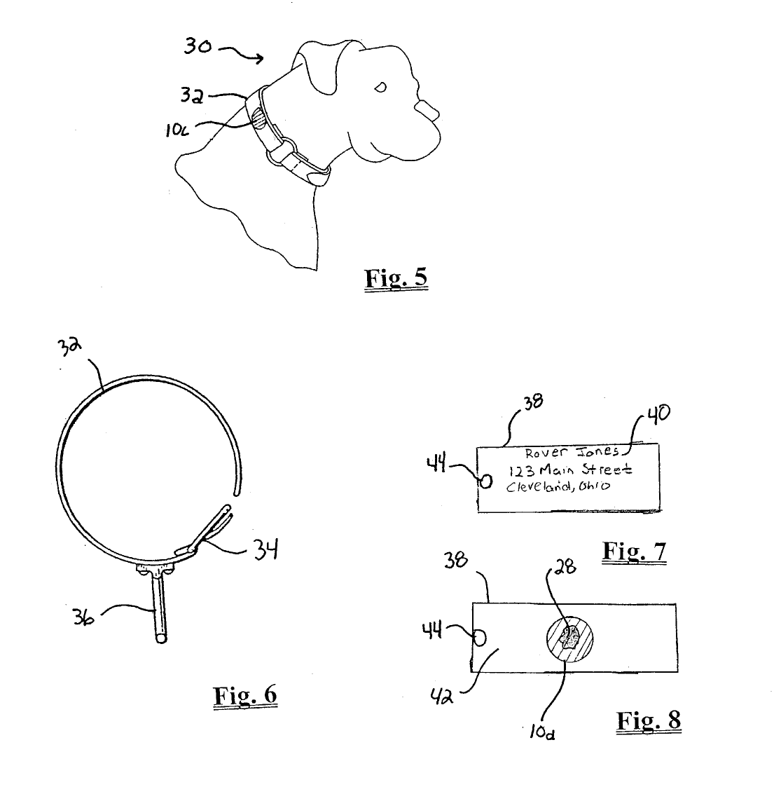

FIG. 5 illustrates a dog 30 wearing a collar 32. It should be understood that many animals could use the device of the present invention and the dog is shown for illustration purposes only. A small toxic material senor 10 is positioned on the collar 32.

FIG. 6 illustrates a typical pet collar 32. The collar 32 comprises a band which is positioned around the neck of the pet and a fastener 34 to hold the collar 32 in place. Many pet collars include a means for attaching an identification tag 36 to the collar. Identification tags are illustrated in FIGS. 7 and 8. Such identification tags 38 generally include a means for attaching the tag to a pet collar 44. On at least one surface of the tag, identification information 40 may be printed. The identification information may include, but is not limited to the pet's name, owner's name, address, phone number or any other means for identifying the pet and its owner.

In one embodiment of the present invention, the toxic material sensor/indicator would be formed or cut into a size or shape such that an indicator could be positioned on a pet's collar 32 or tag 38 (FIGS. 7-8). In one embodiment, the indicators would be provided with an adhesive backing. The adhesive backing may be a pressure sensitive adhesive or a removable glue like backing. In this embodiment, the indicator 10 would be positioned on the pet's collar (FIG. 5) or on a tag 38 attached to the pet's collar 32. As illustrated in FIG. 8, the indicator is attached to the surface of the tag opposite the identification information. This positions of the indicator shown herein are included by way of example only and should not be deemed to limit the possible positions of the indicators in any way.

It is contemplated that the indicators could be provided in any number of configurations. For instance, a package containing a plurality of adhesive indicators may be provided. The pet owner can selectively attach an indicator to the pet's tag or collar. It is also contemplated that the indicators be removable. Once an indicator has detected some toxic exposure, the used indicator can be removed and discarded and a new indicator can be positioned on the collar or tag. In another embodiment, entire pet collars may be coated with an indicator coating.

It should also be understood that the indicator of the present invention could be used for additional applications other than pets. For instance, parent's might want to be alerted when their children have come into contact with potentially hazardous chemicals. In these cases, parents could attach an indicator sticker to their child's clothing. In the alternative, the indicator may be associated with jewelry or other wearable articles for people.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Therefore, the scope of the invention is to be limited only by the following claims.

What is claimed is:

1. A toxic material sensor comprising:
a generally inert porous substrate, said porous substrate having a pore size dependent upon a desired ultimate drop size sensitivity; and
an indicator formulation, said indicator formulation is applied onto said porous substrate forming an indicator coating, said indicator coating provides a surface of said porous substrate with a colored surface, whereupon said colored surface becoming a discolored spot upon contact with a toxic material such that a hue of the colored surface is clearly distinguishable in relation to said discolored spot.

2. The toxic material sensor of claim 1, wherein said discolored spot producing an enlarged discolored spot resulting from spontaneous bleaching and wicking effect of the toxic material being trapped within said porous substrate.

3. The toxic material sensor of claim 1, wherein said porous substrate is defined as sintered particles of compounds including polyethylene, polypropylene, nylon, and polyvinyl.

4. The toxic material sensor of claim 1, wherein said pore size of said porous substrate is approximately 30 micrometers.

5. The toxic material sensor of claim 1, wherein said indicator formulation is applied onto said porous substrate via spraying, painting, dipping, or other suitable method.

6. The toxic material sensor of claim 1, wherein said toxic material sensor is positioned on a traditional pet collar, said traditional pet collar comprising:
a band, said band positioned around a neck of pet;
a fastener, said fastener holds said band in place around the neck of pet; and
identification tag, said identification tag having attachment means for attaching said identification tag to said band, said identification tag having identification information printed on a surface thereof, wherein said toxic material sensor is adapted so as to conform to a size and shape of said identification tag, and wherein said toxic material sensor is removably adhered to a surface of said identification tag being opposite the identification information.

7. The toxic material sensor of claim 6, wherein said toxic material sensor is removably adhered to the surface of said identification tag being opposite the identification information via an adhesive means including pressure sensitive adhesive backing and removable glue backing.

8. The toxic material sensor of claim 6, wherein said toxic material sensor is adapted so as to conform to a size and shape of a portion of said band, and wherein said toxic material sensor is removably adhered to an outer surface of said band via an adhesive means.

9. A toxic material sensor comprising:
a generally inert porous substrate, said porous substrate having a circuit affixed thereagainst, wherein said circuit having colored particles mixed with a colored indicator paint so as to produce a primary colored circuit which connects a first contact and a second contact, whereupon said primary colored circuit producing a discolored spot upon contact with a toxic material such that a hue of said primary colored circuit is clearly distinguishable in relation to said discolored spot.

10. The toxic material sensor of claim 9, wherein said toxic material sensor is positioned on a traditional pet collar, said traditional pet collar comprising:
a band, said band positioned around a neck of pet;
a fastener, said fastener holds said band in place around the neck of pet; and
identification tag, said identification tag having attachment means for attaching said identification tag to said band, said identification tag having identification information printed on a surface thereof, wherein said toxic material sensor is adapted so as to conform to a size and shape of said identification tag, and wherein said toxic material sensor is removably adhered to a surface of said identification tag being opposite the identification information.

11. The toxic material sensor of claim 10, wherein said toxic material sensor is removably adhered to the surface of said identification tag being opposite the identification information via an adhesive means including pressure sensitive adhesive backing and removable glue backing.

12. The toxic material sensor of claim 10, wherein said toxic material sensor is adapted so as to conform to a size and shape of a portion of said band, and wherein said toxic material sensor is removably adhered to an outer surface of said band via an adhesive means.
